(19) United States
(12) Patent Application Publication
(10) Pub. No.: US 2004/0169671 A1
(43) Pub. Date: Sep. 2, 2004

(54) Effects framework pipeline integration with programmable shader

(76) Inventors: David Floyd Aronson, Woodinville, WA (US); Anuj B. Gosalia, Redmond, WA (US); Craig C. Peeper, Bellevue, WA (US); Loren McQuade, Bellevue, WA (US); David John Martin, Redmond, WA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/376,376

(22) Filed: Mar. 1, 2003

(51) Int. Cl. G09G 5/00

(52) U.S. Cl. 345/700

(57) ABSTRACT

Systems and methods for the integration of an effects framework pipeline with one or more programmable shaders of a computer graphics pipeline is provided. In an illustrative implementation, one ore more component interfaces is provided that allow for the communication and processing of data by one or more cooperating components of a computer graphics pipeline. The component interfaces operate on a data file having high level programming computer instruction sets that, inter alia, provide a manner to express one or more constraints and/or variables for desired constraints. In operation, the cooperating components, such as programmable shaders, of the computer graphics pipeline perform one or more steps according to the instruction sets found in the effects data file. The instruction sets are designed to allow a plain language expression of a desired effect without requiring knowledge of the machine level operations of the computer graphics pipeline.

### COPYRIGHT NOTICE AND PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright© 2002, Microsoft Corp.

1. Field of the Invention

The present invention is directed to systems and methods for programmable shaders in connection with computer graphics. More particularly, the present invention is related to systems and methods for providing the integration of an effect framework pipeline with programmable shaders.

2. Background of the Invention

Rendering and displaying three dimensional (3-D) graphics typically involves many calculations and computations. For example, to render a 3-D object, a set of coordinate points or vertices that define the object to be rendered are formed. Vertices can be joined to form polygons that define the surface of the object to be rendered and displayed. Once the vertices that define an object are formed, the vertices can be transformed from an object or model frame of reference to a world frame of reference and finally to 2-D coordinates that can be displayed on a flat display device, such as a monitor. Along the way, vertices may be rotated, scaled, eliminated or clipped because they fall outside of a viewable area, lit by various lighting schemes and sources, colorized, otherwise transformed, shaded and so forth. The processes involved in rendering and displaying a 3-D object can be computationally intensive and may involve a large number of vertices.

Conventionally, as illustrated in FIG. 1, complex 3-D objects, or portions thereof, can be represented by collections of adjacent triangles (“a mesh”) representing the approximate geometry of the 3-D object, or by a geometry map, or surface, in two dimensional (2-D) surface space. The mesh can be specified through the position of the vertices of the triangles. One or more texture maps can be mapped to the surface to create a textured surface according to a texture mapping process. In this regard, signals textured over a surface can be very general, and can specify any sort of intermediate result that can be input to transformation mechanism(s), such as shader procedure(s), to produce a final color and/or other values associated with a point sample.

After texture sampling, additional transformations, such as shading algorithms and techniques, can optionally be applied to the textured surface prior to rendering the image with picture elements (pixels) of a display device, or outputting the data to somewhere else for some purpose other than display. Images in computer graphics are typically represented as a 2-D array of discrete values (grey scale) or as three 2-D arrays of discrete values (color). Using a standard (x, y, z) rectangular coordinate system, a surface can be specified as a mesh (e.g., triangle mesh) with an (x,y,z) coordinate per mesh vertex, or as a geometry map in which the (x,y,z) coordinates are specified as a rectilinear image over a 2D (u,v) coordinate system, sometimes termed the surface parameterization domain. Texture map(s) can also be specified with the (u,v) coordinate system.

Point samples in the surface parametrization domain, where signals have been attached to the surface, including its geometry, can be generated from textured meshes or geometry maps. These samples can be transformed and shaded using a variety of computations. At the end of this transformation and shading processing, a point sample includes (a) positional information, i.e., an image address indicating where in the image plane the point maps to and (b) textured color, or grey scale, information that indicates the color of the sample at the position indicated by the positional information. Other data, such as depth information of the point sample to allow hidden surface elimination, weight, or any other useful information about the point sample can also be included. The transformed, textured surface is placed in a frame buffer prior to being rendered by a display in 2-D pixel image space (x,y). At this point, in the case of a black and white display device, each (x,y) pixel location in 2-D image space is assigned a grey value in accordance with some function of the surface in the frame buffer. In the case of a typical color display device, each (x,y) pixel location in 2-D image space is assigned red, green and blue (RGB) values. It is noted that a variety of color formats other than RGB exist as well. While variations of the architecture, from start to finish, the above-described vehicle for the crunching of massive amounts of graphics vertex and pixel data is known as the graphics pipeline.

The computer graphics industry and graphics pipelines have seen a particularly tremendous amount of growth in the last few years. For example, current generations of computer games are moving to three dimensional (3-D) graphics in an ever increasing and more realistic fashion. At the same time, the speed of play is driven faster and faster. This combination has fueled a genuine need for the rapid rendering of 3-D graphics in relatively inexpensive systems.

As early as the 1970s, 3-D rendering systems were able to describe the “appearance” of objects according to parameters. These and later methods provide for the parameterization of the perceived color of an object based on the position and orientation of its surface and the light sources illuminating it. In so doing, the appearance of the object is calculated therefrom. Parameters further include values such as diffuse color, the specular reflection coefficient, the specular color, the reflectivity, and the transparency of the material of the object. Such parameters are globally referred to as the shading parameters of the object.

Early systems could only ascribe a single value to shading parameters and hence they remained constant and uniform across the entire surface of the object. Later systems allowed for the use of non-uniform parameters (transparency for instance) that might have different values over different parts of the object. Two prominent and distinct techniques have been used to describe the values taken by these non-uniform parameters on the various parts of the object's surface: procedural shading and texture mapping. Texture mapping is pixel based and resolution dependent.

Procedural shading describes the appearance of a material at any point of a 1-D, 2-D or 3-D space by defining a function (often called the procedural shader) in this space into shading parameter space. The object is “immersed” in the original 1-D, 2-D or 3-D space and the values of the shading parameters at a given point of the surface of the object are defined as a result of the procedural shading function at this point. For instance, procedural shaders that approximate appearance of wood, marble or other natural materials have been developed and can be found in the literature.

The rendering of graphics data in a computer system is a collection of resource intensive processes. The process of shading, i.e., the process of performing complex algorithms upon set(s) of specialized graphics data structures, used to determine values for certain primitives, such as color, etc. associated with the graphics data structures, exemplifies such a computation intensive and complex process. Generally the process of shading has been normalized to some degree. By passing source code designed to work with a shader into an application, a shader becomes an object that the application may create/utilize in order to facilitate the efficient drawing of complex video graphics. Vertex shaders and pixel shaders are examples of such shaders.

Prior to their current implementation in specialized hardware chips, vertex and pixel shaders were sometimes implemented wholly or mostly as software code, and sometimes implemented as a combination of more rigid pieces of hardware with software for controlling the hardware. These implementations frequently contained a CPU or emulated the existence of one using the system's CPU. For example, the hardware implementations directly integrated a CPU chip into their design to perform the processing functionality required of shading tasks. While a CPU adds a lot of flexibility to the shading process because of the range of functionality that a standard processing chip offers, the incorporation of a CPU adds overhead to the specialized shading process. Without today's hardware state of the art, however, there was little choice.

Today, though, existing advances in hardware technology have facilitated the ability to move functionality previously implemented in software into specialized hardware. As a result, today's pixel and vertex shaders are implemented as specialized and programmable hardware chips. Today's hardware designs of vertex and pixel shader chips are highly specialized and thus do not behave like CPU hardware implementations of the past.

Specialized 3-D graphics APIs have been developed that expose the specialized functionality of today's vertex and pixel shaders. In this regard, a developer is able to download instructions to a vertex shader that effectively program the vertex shader to perform specialized behavior. For instance, APIs expose functionality associated with increased numbers of registers in vertex shaders, e.g., specialized vertex shading functionality with respect to floating point numbers at a register level. In addition, it is possible to implement an instruction set that causes the extremely fast vertex shader to return only the fractional portion of floating point numbers. A variety of functionality can be achieved through downloading these instructions, assuming the instruction count limit of the vertex shader is not exceeded.

Similarly, with respect to pixel shaders, specialized pixel shading functionality can be achieved by downloading instructions to the pixel shader. For instance, functionality is exposed that provides a linear interpolation mechanism in the pixel shader. Furthermore, the functionality of many different operation modifiers are exposed to developers in connection with instruction sets tailored to pixel shaders. For example, negating, remapping, biasing, and other functionality are extremely useful for many graphics applications for which efficient pixel shading is desirable, yet as they are executed as part of a single instruction they are best expressed as modifiers to that instruction. In short, the above functionality is advantageous for a lot of graphics operations, and their functional incorporation into already specialized pixel and vertex shader sets of instructions adds tremendous value from the perspective of ease of development and improved performance. A variety of functionality can thus be achieved through downloading these instructions, assuming the instruction count limit of the pixel shader is not exceeded.

Commonly assigned copending U.S. patent application. Ser. No. 09/801,079, filed Mar. 6, 2001, provides such exemplary three-dimensional (3-D) APIs for communicating with hardware implementations of vertex shaders and pixel shaders having local registers. With respect to vertex shaders, API communications are described therein that may make use of an on-chip register index and API communications are also provided for a specialized function, implemented on-chip at a register level, which outputs the fractional portion(s) of input(s). With respect to pixel shaders, API communications are provided for a specialized function, implemented on-chip at a register level, that performs a linear interpolation function and API communications are provided for specialized modifiers, also implemented on-chip at a register level, that perform modification functions including negating, complementing, remapping, biasing, scaling and saturating. Advantageously, the API communications expose very useful on-chip graphical algorithmic elements to a developer while hiding the details of the operation of the vertex shader and pixel shader chips from the developer.

Commonly assigned copending U.S. patent application. Ser. No. 09,796,577, filed Mar. 1, 2001, also describes 3-D APIs, which expose unique algorithmic elements to developers for use with procedural shaders via a mechanism that is conceptually below or inside the software interface, and enable a developer to download instructions to the procedural shaders, and GPU. For instance, such a 3-D API enables operations to be downloadable to a 3-D chip for improved performance characteristics. These 3-D APIs take advantage of cutting edge 3-D graphics chips that have begun to handle such programmable functionality, by including flexible on chip processing and limited on chip memory, to remove custom graphics code from the processing of the host processor and to place such programmable and downloadable functionality in a graphics chip. Such APIs make it so that programming or algorithmic elements written by the developer can be downloaded to the chip, thereby programming the chip to perform those algorithms at improved performance levels. Related to this case where a developer may write a routine downloadable to the 3-D chip, there are also set(s) of algorithmic elements that are provided in connection with the 3-D API (routines that are not written by the developer, but which have already been programmed for the developer). Similarly, a developer can download these pre-packaged API algorithms to a programmable 3-D chip for improved performance. The ability to download 3-D algorithmic elements provides improved performance, greater control as well as development ease.

Thus, the introduction of programmable operations on a per vertex and per pixel basis has become more wide spread in modem graphics hardware. This general programmability allows a vast potential for sophisticated creative algorithms at increased performance levels. However, there are some limitations to what can be achieved. Typically, with present day rendering pipelines at the vertex and pixel shaders, as illustrated in FIG. 2A, a stream of geometry data SGD is input to the vertex shader 200 to perform some operation of the vertices, after which a rasterizer 210 rasterizes the geometry data to pixel data, outputting a stream of pixel data SPD1. The vertex shader 200 may receive instructions which program the vertex shader 200 to perform specialized functionality, but there are limits to the size and complexity of the vertex shader instructions. Similarly, a pixel shader 220 can optionally perform one or more transformations to the data outputting a stream of pixel data SPD2. The pixel shader 220 may also receive instructions which program the pixel shader 220 to perform specialized functionality, but there are limits to the size and complexity to the pixel shader instructions. Thus, one limit to today's APIs and corresponding hardware is that most hardware has a very limited instruction count. This limited instruction count prevents implementation of some of the most sophisticated algorithms by the developer using the APIs. Additionally, the current programmable hardware has very limited mechanisms to exchange data between separate programs, i.e., a first pixel shader program cannot re-use data output from a second pixel shader program.

Additionally, as illustrated in FIG. 2A, a pixel is commonly thought of as a point in the 2-D grid of image space, having a grey scale value or color values associated therewith; however, modem graphics regards a pixel in the pixel engine pipeline as any collective data associated with a point in any 2-D array, whether it be relevant to a displayed image or not. For instance, while FIG. 2A illustrates a pixel having a bucket for Red, a bucket for Green and a bucket for Blue, this need not be the case, and any number of buckets and corresponding values can be a pixel. Thus, there is considerable flexibility in generating a 2-D array of pixel data, which could include parameter values for lighting effects, weight, z-buffer information, etc. A problem with today's graphics pipeline, as illustrated in FIG. 2C, relates to the flexibility of integrating and programming effects in programmable shaders. An effect can generally be considered a constraint of computer graphics content. Exemplary effects relate to the color, texture, and geometry of the computer graphics content. Current graphics pipeline architectures require the use of machine language instructions which are, generally, hard coded, with the desired effects. Such process is arduous, cumbersome, and rigid lending to a lack of ease in applying desired effects on graphical content.

It would thus be desirable to implement systems and methods that overcome the shortcomings of present programmability of effects in connection with present graphics pipelines architectures, APIs and hardware due to limitations in instruction count, limitations in form of output and the lack of efficient and ease in the integration of effects.

### SUMMARY OF THE INVENTION

In view of the foregoing, the present invention provides systems and methods for providing the integration of an effects framework pipeline with programmable shaders to apply effects on computer graphics in a computer system. In various embodiments, the invention provides and utilizes a high level computer readable programming language (i.e. computer instructions) that is processed by cooperating programmable shaders to allow for the robust and flexible application of desired effects on computer graphics. In an illustrative implementation, the effects pipeline has hooks (i.e. component interfaces) with one or more cooperating components of the computer graphics pipeline that allows for the communication of effects data across the pipeline. The data is generally communicated through an effects file which, inter alia, contains one or more instructions for one or more components of the computer graphics pipeline to process effect data for rendering and display. In the contemplated implementation, the effects file data is communicated as part of a high level computer programming instruction set that, inter alia, may be used to define the constraints of the desired effect. Included in such constraints are processing instructions for one or more individualized cooperating components of the graphics pipeline.

Other features and embodiments of the present invention are described below.

### BRIEF DESCRIPTION OF THE DRAWINGS

The system and methods for providing the integration of a effects framework pipeline with a computer graphics pipeline having programmable shaders in accordance with the herein described systems and methods are further described with reference to the accompanying drawings in which:

FIG. 1 provides an overview of the process of a graphics pipeline in a computer graphics system;

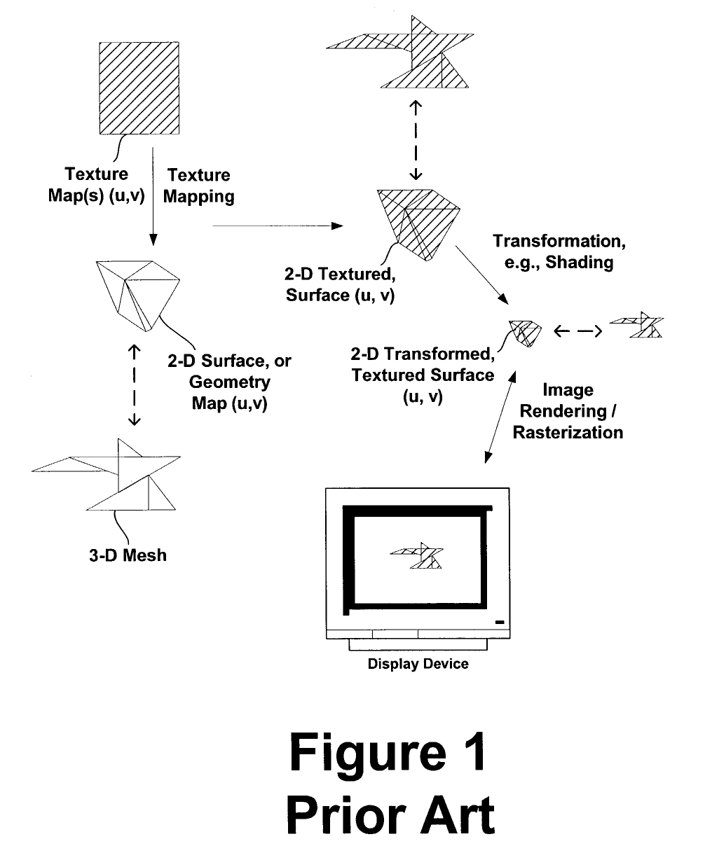

FIGS. 2A to 2C illustrate various limitations of and problems with prior art graphics pipelines;

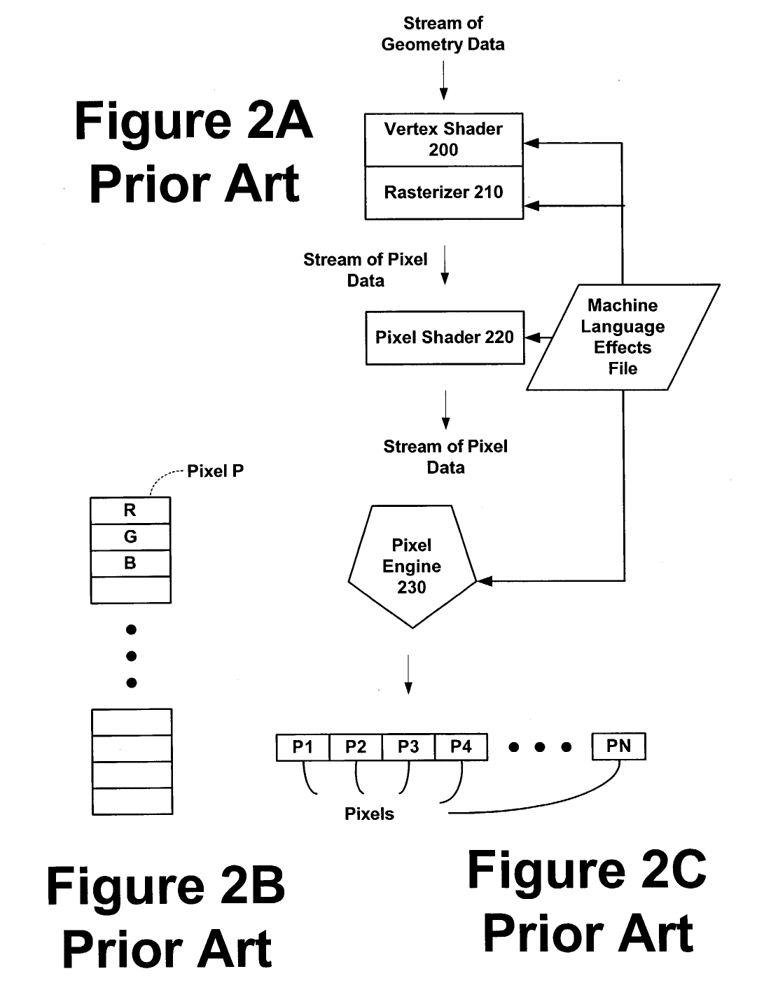

FIG. 3A is a block diagram representing an exemplary network environment having a variety of computing devices in which the present invention may be implemented;

FIG. 3B is a block diagram representing an exemplary non-limiting computing device in which the present invention may be implemented;

FIG. 4 is a block diagram of an exemplary computer graphics pipeline showing the interaction of the various cooperating components of the graphics pipeline;

FIG. 5 is an exemplary flow diagram illustrating the use of the effects framework pipeline in integrating a desired effect with a given computer graphics content; and

FIG. 6 is a block diagram illustrating the interrelationship of the various components of a the effects framework pipeline in accordance with the herein described systems and methods.

### DETAILED DESCRIPTION OF THE ILLUSTRATIVE IMPLEMENTATION

Overview

As described above, the present invention the integration of an high level effects language in existing computer graphics pipelines to allow ease in the application of effects to computer graphics. Existing practices rely on machine level instruction sets to communicate data representative of desired effects to one or more cooperating components of a computer graphics pipeline. Such practice is extremely arduous requiring knowledge of the machine level processing routines of the computer graphics pipeline components. Moreover, current practices are generally realized through draconian expressions of desired effects, providing little to no insight as to the constraints and/or features of the effects to be applied on the computer graphics

The systems and methods described herein aim to ameliorate the shortcomings of existing practices by providing a comprehensive effects framework pipeline that is integrated with one or more cooperating components of a computer graphics pipeline. Included in the effects framework pipeline are high level computer programming instruction sets that provide one or more instructions to one or more of the computer graphics pipeline to realize a desired effect on computer graphics content. In operation, a data file having the high level computer programming instruction sets acts as input to one or more cooperating computer graphics pipeline components through one or more computer graphics pipeline interfaces. The instruction sets have, inter alia, information representative of on or more of the features or variables of the desired effect. Moreover, the instruction sets have one ore more instructions providing for alternative applications of effects providing for the robust expression and implementation of effects on computer graphics content.

Exemplary Networked and Distributed Environments

One of ordinary skill in the art can appreciate that a computer or other client or server device can be deployed as part of a computer network, or in a distributed computing environment. In this regard, the present invention pertains to any computer system having any number of memory or storage units, and any number of applications and processes occurring across any number of storage units or volumes, which may be used in connection with the intermediate memory targets of the invention. The present invention may apply to an environment with server computers and client computers deployed in a network environment or distributed computing environment, having remote or local storage. The present invention may also be applied to standalone computing devices, having programming language functionality, interpretation and execution capabilities for generating, receiving and transmitting information in connection with remote or local services.

Distributed computing facilitates sharing of computer resources and services by direct exchange between computing devices and systems. These resources and services include the exchange of information, cache storage, and disk storage for files. Distributed computing takes advantage of network connectivity, allowing clients to leverage their collective power to benefit the entire enterprise. In this regard, a variety of devices may have applications, objects or resources that may implicate the intermediate memory targets of the invention.

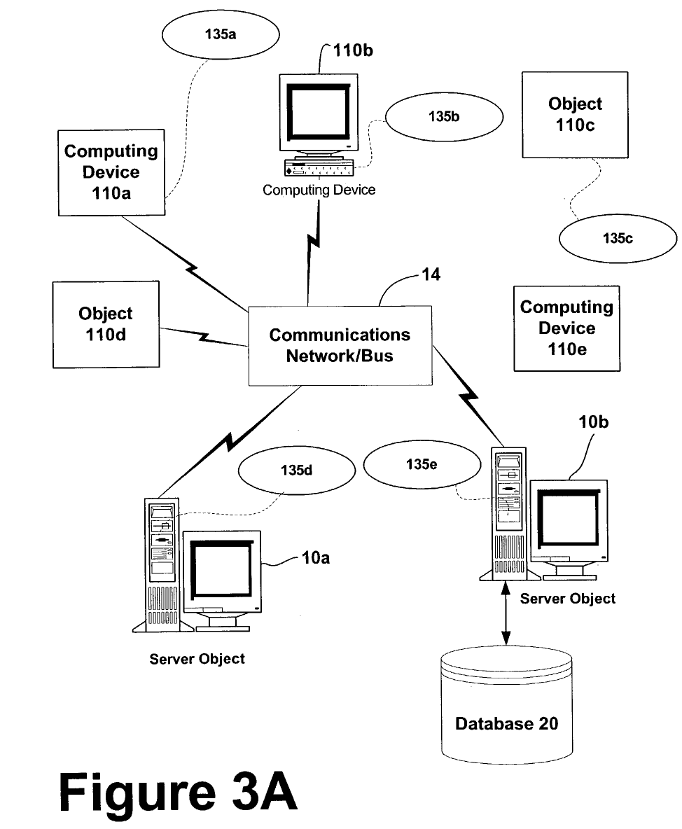

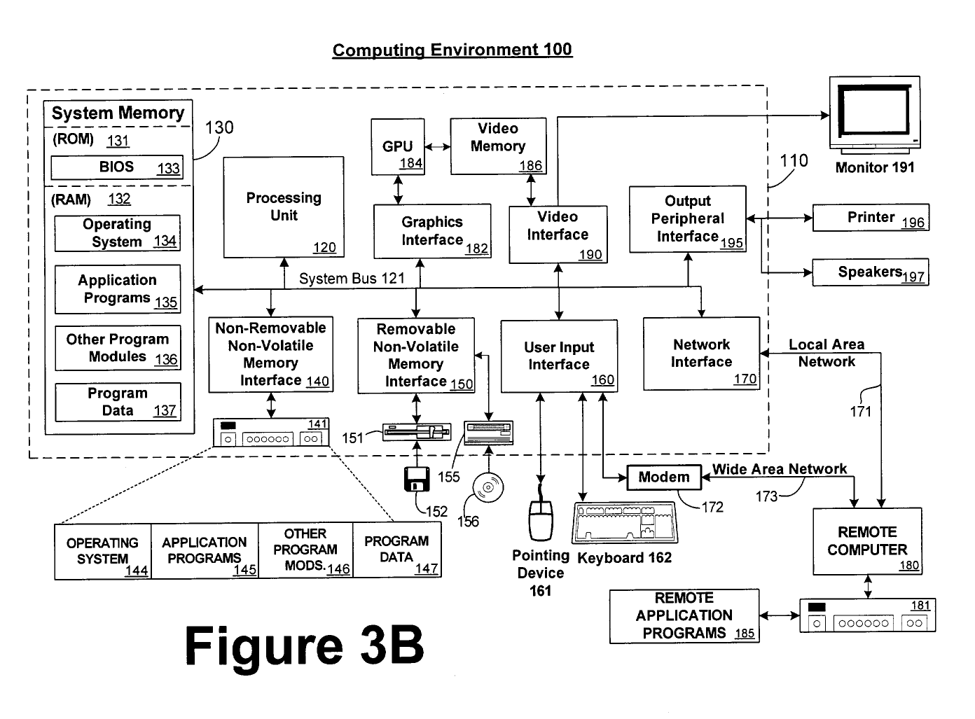

FIG. 3A provides a schematic diagram of an exemplary networked or distributed computing environment. The distributed computing environment comprises computing objects 10a, 10b, etc. and computing objects or devices 110a, 110b, 110c, etc. These objects may comprise programs, methods, data stores, programmable logic, etc. The objects may comprise portions of the same or different devices such as PDAs, televisions, MP3 players, televisions, personal computers, etc. Each object can communicate with another object by way of the communications network 14. This network may itself comprise other computing objects and computing devices that provide services to the system of FIG. 3A. In accordance with an aspect of the invention, each object 10a, 10b, etc. or 110a, 110b, 110c, etc. may contain an application that might make use of an API, or other object, to request use of the intermediate memory targets of the invention.

In a distributed computing architecture, computers, which may have traditionally been used solely as clients, communicate directly among themselves and can act as both clients and servers, assuming whatever role is most efficient for the network. This reduces the load on servers and allows all of the clients to access resources available on other clients, thereby increasing the capability and efficiency of the entire network. Services that use the intermediate targets in accordance with the present invention may thus be distributed among clients and servers, acting in a way that is efficient for the entire network.

Distributed computing can help businesses deliver services and capabilities more efficiently across diverse geographic boundaries. Moreover, distributed computing can move data closer to the point where data is consumed acting as a network caching mechanism. Distributed computing also allows computing networks to dynamically work together using intelligent agents. Agents reside on peer computers and communicate various kinds of information back and forth. Agents may also initiate tasks on behalf of other peer systems. For instance, intelligent agents can be used to prioritize tasks on a network, change traffic flow, search for files locally or determine anomalous behavior such as a virus and stop it before it affects the network. All sorts of other services may be contemplated as well. Since graphical object(s), texture maps, shading data, etc. may in practice be physically located in one or more locations, the ability to distribute services that make use of the intermediate targets described herein is of great utility in such a system.

It can also be appreciated that an object, such as 110c, may be hosted on another computing device 10a, 10b, etc. or 110a, 10b, etc. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wireline or wireless systems, by local networks or widely distributed networks. Currently, many of the networks are coupled to the Internet, which provides the infrastructure for widely distributed computing and encompasses many different networks.

In home networking environments, there are at least four disparate network transport media that may each support a unique protocol, such as Power line, data (both wireless and wired), voice (e.g., telephone) and entertainment media. Most home control devices such as light switches and appliances may use power line for connectivity. Data Services may enter the home as broadband (e.g., either DSL or Cable modem) and are accessible within the home using either wireless (e.g., HomeRF or 802.11b) or wired (e.g., Home PNA, Cat 5, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also emerging as digital interconnects for clusters of media devices. All of these network environments and others that may emerge as protocol standards may be interconnected to form an intranet that may be connected to the outside world by way of the Internet. In short, a variety of disparate sources exist for the storage and transmission of data, and consequently, moving forward, computing devices will require ways of sharing data, such as data accessed or utilized incident to program objects which make use of intermediate results of intermediate targets in accordance with the present invention.

The Internet commonly refers to the collection of networks and gateways that utilize the TCP/IP suite of protocols, which are well-known in the art of computer networking. TCP/IP is an acronym for “Transport Control Protocol/Interface Program.” The Internet can be described as a system of geographically distributed remote computer networks interconnected by computers executing networking protocols that allow users to interact and share information over the networks. Because of such wide-spread information sharing, remote networks such as the Internet have thus far generally evolved into an open system for which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 3A, computers 110a, 110b, etc. can be thought of as clients and computer 10a, 10b, etc. can be thought of as the server where server 10a, 10b, etc. maintains the data that is then replicated in the client computers 110a, 110b, etc.

A server is typically a remote computer system accessible over a remote network such as the Internet. The client process may be active in a first computer system, and the server process may be active in a second computer system, communicating with one another over a communications medium, thus providing distributed functionality and allowing multiple clients to take advantage of the information-gathering capabilities of the server.

Client and server communicate with one another utilizing the functionality provided by a protocol layer. For example, Hypertext-Transfer Protocol (HTTP) is a common protocol that is used in conjunction with the World Wide Web (WWW). Typically, a computer network address such as a Universal Resource Locator (URL) or an Internet Protocol (IP) address is used to identify the server or client computers to each other. The network address can be referred to as a URL address. For example, communication can be provided over a communications medium. In particular, the client and server may be coupled to one another via TCP/IP connections for high-capacity communication.

Thus, FIG. 3A illustrates an exemplary networked or distributed environment, with a server in communication with client computers via a network/bus, in which the present invention may be employed. In more detail, a number of servers 10a, 10b, etc., are interconnected via a communications network/bus 14, which may be a LAN, WAN, intranet, the Internet, etc., with a number of client or remote computing devices 110a, 110b, 110c, 110d, 110e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to process graphical object(s).

In a network environment in which the communications network/bus 14 is the Internet, for example, the servers 10a, 10b, etc. can be Web servers with which the clients 110a, 110b, 110c, 110d, 110e, etc. communicate via any of a number of known protocols such as HTTP. Servers 10a, 10b, etc. may also serve as clients 110a, 110b, 110c, 110d, 110e, etc., as may be characteristic of a distributed computing environment. Communications may be wired or wireless, where appropriate. Client devices 110a, 10b, 110c, 110d, 110e, etc. may or may not communicate via communications network/bus 14, and may have independent communications associated therewith. For example, in the case of a TV or VCR, there may or may not be a networked aspect to the control thereof. Each client computer 110a, 110b, 110c, 110d, 110e, etc. and server computer 10a, 10b, etc. may be equipped with various application program modules or objects 135 and with connections or access to various types of storage elements or objects, across which files may be stored or to which portion(s) of files may be downloaded or migrated. Any computer 10a, 10b, 110a, 110b, etc. may be responsible for the maintenance and updating of a database 20 or other storage element in accordance with the present invention, such as a database or memory 20 for storing graphics object(s) or intermediate graphics object(s) or data processed according to the invention. Thus, the present invention can be utilized in a computer network environment having client computers 110a, 110b, etc. that can access and interact with a computer network/bus 14 and server computers 10a, 10b, etc. that may interact with client computers 110a, 110b, etc. and other like devices, and databases 20.

Exemplary Computing Device

FIG. 3B and the following discussion are intended to provide a brief general description of a suitable computing environment in which the invention may be implemented. It should be understood, however, that handheld, portable and other computing devices and computing objects of all kinds are contemplated for use in connection with the present invention. While a general purpose computer is described below, this is but one example, and the present invention may be implemented with a thin client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance. In essence, anywhere that data may be stored or from which data may be retrieved is a desirable, or suitable, environment for operation of the graphics pipeline techniques of the invention.

Although not required, the invention can be implemented via an operating system, for use by a developer of services for a device or object, and/or included within application software that operates in connection with intermediate targets of the invention. The invention also implicates the design of vertex shaders and pixel shaders as well in order to interact with the intermediate targets of the invention. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like. The invention may also be practiced in distributed computing environments where tasks are performed by remote processing devices that are linked through a communications network/bus or other data transmission medium. In a distributed computing environment, program modules may be located in both local and remote computer storage media including memory storage devices, and client nodes may in turn behave as server nodes.

FIG. 3B thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 3B, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 3B illustrates operating system 134, application programs 135, other program modules 136, and program data 137.

The computer 110 may also include other removable/non-removable, volatile/nonvolatile computer storage media. By way of example only, FIG. 3B illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 3B provide storage of computer readable instructions, data structures, program modules and other data for the computer 110. In FIG. 3B, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186, wherein the intermediate targets of the invention may be implemented. GPUs 184, however, are but one example of a coprocessor and thus a variety of coprocessing devices may be included in computer 110, and may include a variety of procedural shaders, such as pixel and vertex shaders. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 3B. The logical connections depicted in FIG. 3B include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 3B illustrates remote application programs 185 as residing on memory device 181. It will be appreciated that the network connections shown are exemplary and other means of establishing a communications link between the computers may be used.

Exemplary Distributed Computing Frameworks or Architectures

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT(®)'s NET platform includes servers, building-block services, such as Web-based data storage and downloadable device software. Generally speaking, the NET platform provides (1) the ability to make the entire range of computing devices work together and to have user information automatically updated and synchronized on all of them, (2) increased interactive capability for Web sites, enabled by greater use of XML rather than HTML, (3) online services that feature customized access and delivery of products and services to the user from a central starting point for the management of various applications, such as e-mail, for example, or software, such as Office NET, (4) centralized data storage, which will increase efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors and (7) many other cross-platform integration features as well.

While exemplary embodiments herein are described in connection with software residing on a computing device, one or more portions of the invention may also be implemented via an operating system, application programming interface (API) or a “middle man” object between a coprocessor and requesting object, such that controllable texture sampling services may be performed by, supported in or accessed via all of .NET's languages and services, and in other distributed computing frameworks as well. Additionally, another aspect to the invention is the intermediate targets themselves residing in video memory, as well as the graphics architecture that permits procedural shaders to receive programs from the API, and translate them to various intermediate targets.

Exemplary Computer Graphics Pipeline and Cooperation of the Effects Framework Pipeline

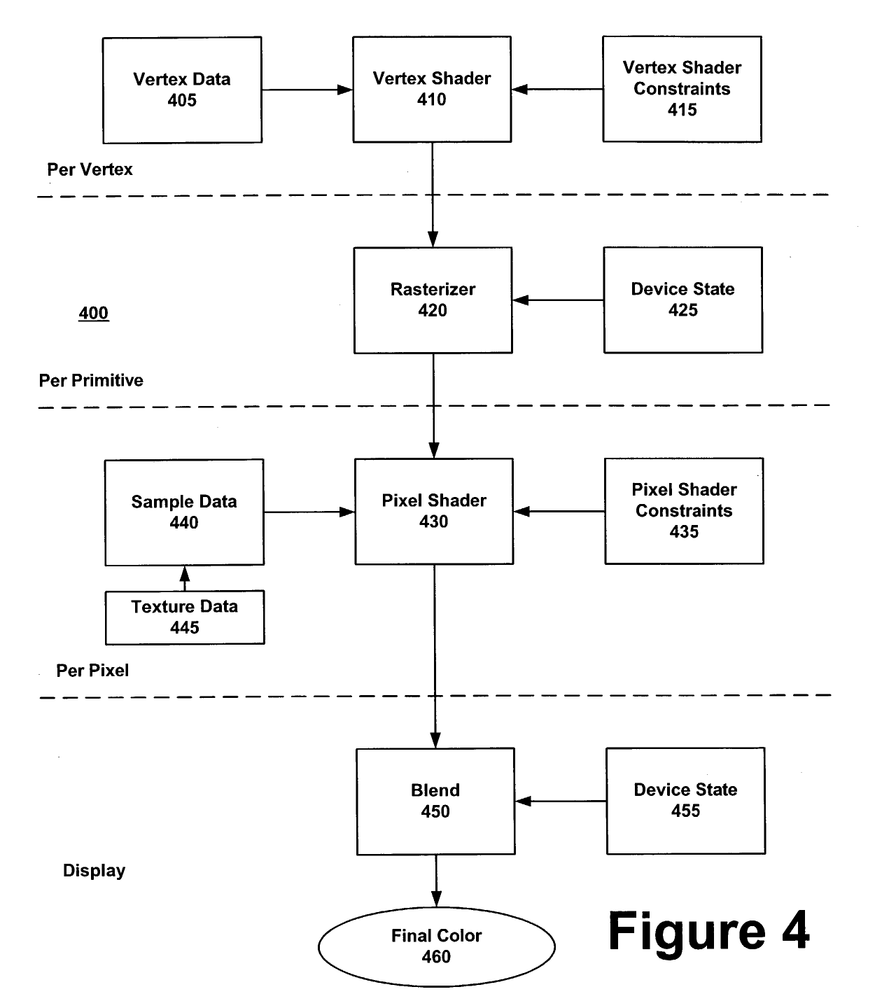

FIG. 4 shows the interaction of an exemplary effects framework pipeline 400 with various components of an illustrative computer graphics pipeline. As shown, illustrative computer graphics pipeline architecture comprises 400 of four general processing areas (as demarcated by the dashed lines). The four processing areas process computer graphics content in its various forms as it passes through the computer graphics pipeline. The graphics content, as shown, originates as vertex data. The vertex is then processed to generate primitives, which in turn are further processed to generate pixels. The pixels are then prepared for display.

More specifically, vertex data 405 is processed by vertex shader 410 using vertex shader constraints 415. Vertex shader 410, among other things, is responsible for adding color and shading to the vertex data which will ultimately be expressed in the final displayed computer graphics. The resultant data processed vertex data is then processed by rasterizer 420. As part of the rasterization step, device state information is used which is provided by device state data block 425. The device state information 425 assists exemplary computer graphics pipeline 400 to ascertain if the device supporting the exemplary computer graphics pipeline is in a ready state to benefit from further computer graphics processing. The rasterized data acts as input to pixel shader 430. As shown, pixel shader 430 accepts additional inputs from pixel shader constraint data 435 and sample data 440 which, in turn, provides data representative of texture data 445. Pixel shader 430 provides color and/or shading data per pixel. The output date of pixel shader 430 is then blended, via blender 450 that cooperates with device state data block 455 to produce a final color 460 which is displayed.

In a contemplated implementation of the herein described system and methods, high level computer programming language instruction sets directed to the integration of effects with one or more cooperating components of a computer graphics pipeline is provided through one ore more interfaces (not shown) to the cooperating components of exemplary computer graphics pipeline 400. The interfaces can include but is not limited to application program interfaces, assembly translation interfaces and object code compilation interfaces. This high level computer programming instruction sets comprising the exemplary effects framework pipeline is provided to one or more of the computer graphics pipeline components to realize effect processing and implementation. In the contemplated illustrative implementation, these instruction sets, in operation, provide instructions for vertex shader 410, vertex shader constraints 415, device state data block 425, pixel shader 430, pixel shader constraints 435, and device state data block 455.

Effect Files define a standardized way to control shaders written in the high level shading language and the needed parameters for making them work. This allows effect parameters to be controlled via standard annotations so that they can be easily control of these parameters from the controlling program. The parameters can be constant parameters, variable parameters, or per primitive parameters that are defined by an expression that is computed outside of the vertex shader. The instruction sets may be delivered to the cooperating components of the computer graphics pipeline through one or more effect files.

Generally, effect files can be use to define a standardized way to control shaders written in the high level shading language and the needed parameters for making them work. This allows effect parameters to be controlled via standard annotations so that they can be easily control of these parameters from the controlling program. The parameters can be constant parameters, variable parameters, or per primitive parameters that are defined by an expression that is computed outside of the vertex shader.

Specifically, these files also allow for an efficient way to encapsulate the device state so that the device is reset back to its original state after running the effect. This make it possible to enable scalable rendering techniques as the device will always be returned to the state that developer had it set to prior to entering the effect. In operation, the effects can be broken into separate techniques allowing for similar ways of achieving an effect to be grouped together. The actual technique used to draw is chosen based on either an automatic method based on the actual available hardware or a predefined metric chosen by the controlling program. This allows participating developers to define a set of fallbacks that make hardware differences be less of an issue, allowing developers the flexibility to take advantage of the most advanced technique available to them as hardware improves. The consequence is the rapid prototyping of effects as a participating developer can encapsulate and work on specific techniques for new hardware configuration outside of the actual controlling program, allowing the materials and program to be worked on in parallel. By having this separate standardized text format this allows for shader algorithms to be represented in a standard way allowing for their reuse and making them easier to use and debug. This opens up the possibility of having effects be shared across multiple objects in a particular game and multiple games. Moreover, these effect files can be done at author, install, load, or run time allowing for the developer to choose when the optimizations will occur. This makes it easier for effects to be able to be used on multiple hardware platforms and still be efficient for runtime use.

### NON-LIMITING EMBODIMENTS

What follows are non-limiting software implementations of the invention that utilize the above components of the invention. In this regard, the invention expresses a particular effect through an effect file. An exemplary effect file follows, however it is understood and appreciated that the following example, is jut that an example, and does not in any way limit the scope and breadth of the claimed invention:

// effect.fx
texture tex0
<

string name = “tiger.bmp”;

>;
texture tex1
<

string name = “banana.bmp”;

>;
string XFile = “tiger.x”; // Model to load
string BIMG = “lake.bmp”; // Background image
DWORD BCLR = 0xff202080; // Background color (if no image)
// Declare the required matrices with the appropriate semantics
// so that the viewer can supply the necessary matrix information.
float4x4 mProjection : PROJECTION;
float4x3 mWorldView : WORLD VIEW;
float4x4 mViewProjection : VIEWPROJECTION;
// Declare data used by the shaders that the application can modify.
floats vLightDirection = {0.0, 0.0, −1.0 };
float vDisplace = 0.015;
float4 vGlowColor = { 0.5, 0.2, 0.2, 1.0 } ;
float4 vGlow Ambient = { 0.2, 0.2, 0.0, 0.0 };
// Set up an output structure defining the output to the pixel shader.
struct VS_OUTPUT_TEXCOORD0
{

float4 Position : POSITION;
float4 Diffuse : COLOR;
float2 Texture0 : TEXCOORD0;

};
// Helper function to transform position/normal into view space
void TransformUnskinned

(
float4 vPos,
float3 vNormal,
float3 vTransformedPosition,
float3 vTransformedNormal
)

{

// Transform the position into view space
vTransformedPosition = mul(vPos, mWorldView);
// Transform the normal into view space (just use the upper 3x3 of WorldView)
vTransformedNormal = mul(vNormal, (float3x3)mWorldView);

}
// Draws unskinned object with one texture and one directional light.
VS_OUTPUT_TEXCOORD0 Unskinned

(
float4 vPos : POSITION,
float3 vNormal : NORMAL,
float2 vTexCoord0 : TEXCOORD0
)

{

float3 vTransformedPosition = {0,0,0};
float3 vTransformedNormal = {0,0,0};
VS_OUTPUT_TEXCOORD0 Output;
float fDot;
// Transform the position/normal into view space.
TransformUnskinned(vPos, vNormal, vTransformedPosition, vTransformedNormal);
// Calculate amount of light from the one light direction.
fDot = dot(vTransformedNormal, vLightDirection);
// Transform view space position into screen space.
Output.Position = mul(float4(vTransformedPosition, 1.0), mProjection);
// Multiple amount of light times light color.
// Note: Color could be negative with this equation, but will be
// clamped to zero before pixel shader.
Output.Diffuse = float4(1.0f, 1.0f, 1.0f, 1.0f) * fDot;
// Just copy the texture coordinate through.
Output.Texture0 = vTexCoord0;
return Output;

}
// Declare the output of the GlowSkinned vertex shader to the pixel shader.
struct VS_OUTPUT
{

float4 Position : POSITION;
float4 Diffuse : COLOR;

};
// Draws a transparent hull of the unskinned object.
VS_OUTPUT GlowUnskinned

(
float4 vPos : POSITION,
float3 vNormal : NORMAL
)

{

float3 vTransformedPosition = {0,0,0};
float3 vTransformedNormal = {0,0,0};
VS_OUTPUT Output;
float fPower;
// For standard “glow” this is the view direction.
float3 vGlowAxis = float3(0, 0, 1);
// Transform the position and normal into world space.
TransformUnskinned(vPos, vNormal, vTransformedPosition, vTransformedNormal);
// Displace the position by the normal, so that the glow will not

// overlap the non-glowed version.

vTransformedPosition += vTransformedNormal * vDisplace;
// The glow is determined by the angle between the normal and the glow axis.
// This ends up being similar to a fresnel approximation.
fPower = dot(vTransformedNormal, vGlowAxis);
fPower = 1.0f − fPower * fPower;
fPower *= fPower;
// Transform position into screen space from view space.
Output.Position = mul(float4(vTransformedPosition, 1.0), mProjection);
// Output color is the compute power times the glow color.
Output.Diffuse = vGlowColor * fPower + vGlow Ambient;
return Output;

}
// first technique - unskinned
// first pass draw the object normally
// second pass draw the outline
technique GlowOnly
{

pass P1
{

// Generate a 1_1 vertex shader to draw the outline of the object.
VertexShader = compile vs_1_1 GlowUnskinned( );
Texture[0] = NULL;
// Enable alpha blending
AlphaBlendEnable = True;
SrcBlend = One;
DestBlend = One;
// Set up TSS stages to just use the diffuse color.
ColorOp[0] = SelectArg2;
ColorArg2[0] = Diffuse;
AlphaOp[0] = SelectArg2;
AlphaArg2[0] = Diffuse;
ColorOp[1] = Disable;
AlphaOp[1] = Disable;

}

}
// First technique - unskinned
// First pass draw the object normally
// Second pass draw the outline
technique GlowAndNormal
{

pass P0
{

// Generate a 1_1 vertex shader for unskinned
// single texture/one directional light.
VertexShader = compile vs_1_1 Unskinned( );
// Set up texture stage info for single texture.
ColorOp[0] = Modulate;
ColorArg1[0] = Texture;
ColorArg2[0] = Current;
AlphaOp[0] = Disable;
// Set texture filtering.
MinFilter[0] = Linear;
MagFilter[0] = Linear;
MipFilter[0] = Point;
// Set texture into stage 0.
Texture[0] = <tex0>;
//Disable Stage 1.
ColorOp[1] = Disable;
AlphaOp[1] = Disable;

}
pass P1
{

// Generate a 1_1 vertex shader to draw the outline of the object.
VertexShader = compile vs_1_1 GlowUnskinned( );
Texture[0] = NULL;
// Enable alpha blending.
AlphaBlendEnable = True;
SrcBlend = One;
DestBlend = One;
// Set up TSS stages to just use the diffuse color.
ColorOp[0] = SelectArg2;
ColorArg2[0] = Diffuse;
AlphaOp[0] = SelectArg2;
AlphaArg2[0] = Diffuse;
ColorOp[1] = Disable;
AlphaOp[1] = Disable;

}

}

This example contains two techniques. This first technique, called GlowOnly, applies a glow to an object. GlowOnly uses the function Unskinned to calculate lighting and copy the texture coordinates. The Unskinned function also uses the helper function, TransformUnskinned, to transform position and normal data.

Exemplary Use of the Effects Framework Pipeline

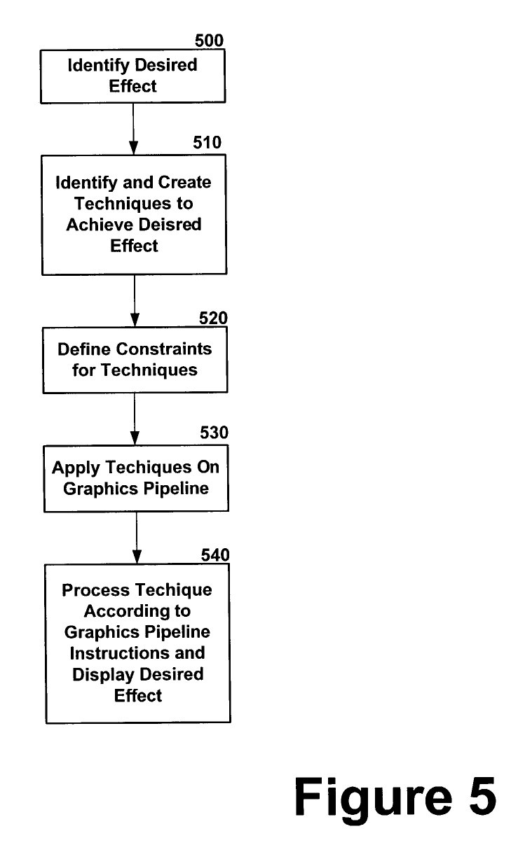

FIG. 5 illustrates the processing performed when integrating an effects framework with one or more programmable shaders. As shown, processing begins at block 500 wherein a desired effect is identified. Processing then proceeds to block 510 wherein one or more techniques are identified and created for each of the identified desired effects. From there, processing proceeds to block 520 where the constraints of the techniques are identified. The technique is then applied at block 530 and the graphics having the desired effect is displayed at block 540. In certain instances, the systems and methods described herein contemplate the cycling of techniques from library of techniques until a suitable technique is found.

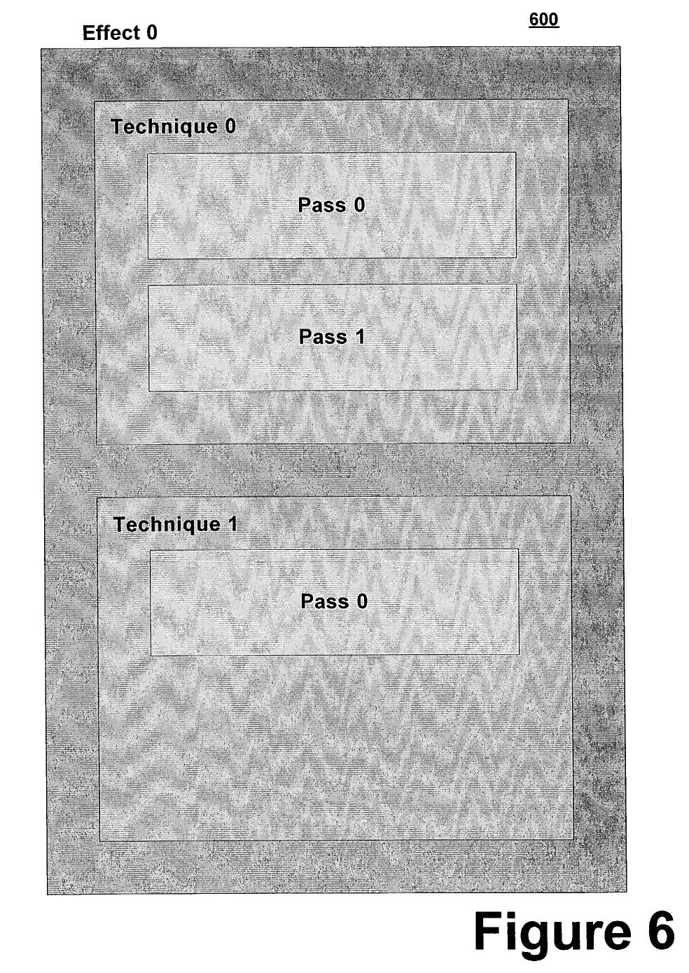

FIG. 6 shows a block diagram of an exemplary effect framework file, which can contain multiple effects that are defined by at least on technique which are composed of at least one pass. The effect describes a particular type of technique that is desired, i.e. a particular visual effect. That visual effect is can then be represented with alternate representations to achieve that effect depending on an either a user defined metric for choosing the technique. The effects framework has an automatic method for evaluating each technique based on the current hardware configuration. Finally each technique is composed of one or more passes that define the actual state encapsulation and instructions for executing the effect.

There are multiple ways of implementing the present invention. One way is to provide an implementation whereby the coprocessor(s), e.g., GPU(s), are pre-fabricated to perform the functionality of the invention, and receive commands suited to the multiple intermediate targets as described herein. Another implementation of the invention includes an appropriate API, tool kit, driver code, operating system, standalone or downloadable software object, etc. which enables applications and services to use the intermediate targets to achieve more complex functionality. The invention contemplates the use of the invention from the standpoint of an API (or other software object), the graphics chip and the video memory. Thus, various implementations of the invention described herein have aspects that are wholly in hardware, partly in hardware and partly in software, as well as in software.

As mentioned above, while exemplary embodiments of the present invention have been described in connection with various computing devices and network architectures, the underlying concepts may be applied to any computing device or system in which it is desirable to program procedural shaders in more than trivial ways. Thus, the techniques for providing improved programmability of procedural shaders in accordance with the present invention may be applied to a variety of applications and devices. For instance, the algorithm(s) and hardware implementations of the invention may be applied to the operating system of a computing device, provided as a separate object on the device, as part of another object, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. One of ordinary skill in the art will appreciate that there are numerous ways of providing object code that achieves the same, similar or equivalent functionality achieved by the API of the invention.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the intermediate target services of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, or a receiving machine having the signal processing capabilities as described in exemplary embodiments above becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method integrating an effects framework pipeline with a computer graphics system comprising the steps of:
providing an effects file, said effects file having a high level computer programming instruction set that instructs one or more components of a computer graphics pipeline to perform one or more acts to implement a desired effect; and
communicating the effects file to the computer graphics pipeline.

2. The method as recited in claim 1, further comprising providing at least one interface mechanism that allows for the communication of one or more portions of data indicative of one or more computer graphics processing instructions from the effects file to the computer graphics pipeline.

3. The method as recited in claim 2, further comprising communicating computer graphics processing instructions from the effects file a vertex shader of the computer graphics pipeline.

4. The method as recited in claim 3, further comprising communicating vertex shader constraint data for use by the vertex shader of the computer graphics pipeline.

5. The method as recited in claim 4, further comprising communicating computer graphics processing instructions from the effects file to a pixel shader of the computer graphics pipeline.

6. The method as recited in claim 5, further comprising communicating pixel shader constraint data for use by the pixel shader of the computer graphics pipeline.

7. The method as recited in claim 1, further comprising processing device state information representative of the state of an underlying computer graphics processing and display device which operates and maintains a computer graphics pipeline.

8. The method as recited in claim 7, further comprising communicating the device state information by any of comprising: a rasterizer of the computer graphics pipeline and a blender of a computer graphics pipeline.

9. The method as recited in claim 1, further comprising processing the instructions from the effects.

10. The method as recited in claim 9, further comprising displaying the desired effect.

11. A computer readable medium having computer readable instructions to instruct a computer to perform the method as recited in claim 1.

12. A system to store variables among components of computer graphics architecture such that the variable name and values are shared to produce an effect comprising,
a effects framework pipeline; and
an interface to allow seamless integration between the effects framework pipeline and the computer graphics architecture.

13. The system as recited in claim 12, wherein the effects framework pipeline comprises high level programming computer instructions to instruct at least one component of the computer graphics architecture to process data representative of a desired effect.

14. The system as recited in claim 13, wherein the high level programming computer instructions are contained in an effects file.

15. The system as recited in claim 14, wherein the effects file has instructions comprising at least one technique, wherein the at least one technique provides processing instructions to implement one ore more portions of the desired effect.

16. The system as recited in claim 15, wherein the at least one technique comprises at least one pass, the pass having more detailed processing instructions for one or more of the cooperating components of the computer graphics architecture.

17. The system as recited in claim 14, wherein the effects file comprises more than one desired effect for integration with the computer graphics architecture.

18. The system as recited in claim 13 thru 17, wherein the computer graphics architecture comprises a computer graphics pipeline having programmable shaders.

19. The system as recited in claim 17, wherein the programmable shaders operate on computer graphics data residing in various formats.

20. The system as recited in claim 19, wherein the various data formats comprises any of vertex shader data, vertex shader constraints, device state data, pixel shader data, pixel shader constraints, and sample data.
